(19) United States
(12) Patent Application Publication
(10) Pub. No.: US 2020/0242941 A1
(43) Pub. Date: Jul. 30, 2020

(54) DRIVER ASSISTANCE SYSTEM, AND CONTROL METHOD THE SAME

(71) Applicant: MANDO CORPORATION, Pyeongtaek-si (KR)

(72) Inventor: Hyun Beom Kim, Seoul (KR)

(21) Appl. No.: 16/709,012

(22) Filed: Dec. 10, 2019

(30) Foreign Application Priority Data
Jan. 30, 2019 (KR) 10-2019-0011786

(51) Int. Cl. G08G 1/16; B62D 15/02

(52) U.S. Cl. CPC G08G 1/167; B62D 15/0295

(57) ABSTRACT

A driver assistance system (DAS) includes a camera configured to be installed on the vehicle to have a field of view and obtain image data, a radar configured to be installed on the vehicle to have a field of view outside and obtain radar data and a controller configured to include a processor to process the image data obtained by the camera and the radar data obtained by the radar data, and the controller identifies an object based on at least one of the image data and the radar data, determines a risk for the object by determining collision possibility with the identified object, and determines driving position of the vehicle within a driving lane based on the risk for the object.

### CROSS-REFERENCE TO RELATED APPLICATION(S)

This application is based on and claims priority under 35 U.S.C. § 119 to Korean Patent Application No. 10-2019-0011786, filed on Jan. 30, 2019 in the Korean Intellectual Property Office, the disclosure of which is incorporated by reference in its entirety.

### BACKGROUND

### 1. Technical Field

Embodiments of the present disclosure relate to a driver assistance system, control method the same.

### 2. Description of the Related Art

Lane Keeping Assist System (Lane Keeping Assist System) is a device that recognizes the lane in which the vehicle travels and maintains the lane without the driver's steering wheel manipulation. Conventional driver assistance systems generally allow a vehicle to travel in the middle of a lane.

However, the conventional driver assistance system has a problem that the safety of autonomous driving is lowered because the driver's assistance system uniformly travels in the center of the lane without considering specific conditions or specific situations occurring during driving of the vehicle.

### SUMMARY

In view of the above, it is an aspect of the present disclosure to provide a driver assistance system and a driver assistance method for determining deflection driving of a vehicle in a driving lane based on a collision risk of an object outside the vehicle.

In accordance with an aspect of the present disclosure, a driver assistance system (DAS) includes a camera configured to be installed on the vehicle to have a field of view and obtain image data, a radar configured to be installed on the vehicle to have a field of view outside and obtain radar data and a controller configured to include a processor to process the image data obtained by the camera and the radar data obtained by the radar data, and the controller may identify an object based on at least one of the image data and the radar data, may determine a risk for the object by determining collision possibility with the identified object, and may determine driving position of the vehicle within a driving lane based on the risk for the object.

The controller may determine the risk for the object by dividing with respect to left-side risk and right-side risk of the vehicle based on the location information of the object.

The controller may determine the driving position of the vehicle to be deflected in the right lane or in the left lane within the driving lane based on the left-side risk and right-side risk of the vehicle.

The controller may determine the risk for the object by determining time to collision with the object based on the location information of the object and behavior information of the vehicle.

The controller may determine the risk for the object by applying weights according to the type of the object.

The controller may control steering system provided in the vehicle such that the vehicle moves to the determined driving position of the vehicle.

The controller may generate a virtual lane for moving the vehicle to the determined driving position of the vehicle.

In accordance with another aspect of present disclosure, the control method of the driver assistance system includes a camera configured to be installed on the vehicle to have a field of view and obtain image data, a radar configured to be installed on the vehicle to have a field of view outside and obtain radar data, and a controller configured to include a processor to process the image data obtained by the camera and the radar data obtained by the radar data, the method includes obtaining the image data by the camera, obtaining the radar data by the radar, identifying an object based on at least one of the image data and the radar data, determining a risk for the object by determining collision possibility with the identified object, and determining driving position of the vehicle within a driving lane based on the risk for the object.

Determining the risk for the object may further comprise determining the risk for the object by dividing with respect to left-side risk and right-side risk of the vehicle based on the location information of the object.

Determining driving position of the vehicle may further comprise determining the driving position of the vehicle to be deflected in the right lane or in the left lane within the driving lane based on the left-side risk and right-side risk of the vehicle.

Determining the risk for the object may comprise determining the risk for the object by determining time to collision with the object based on the location information of the object and behavior information of the vehicle.

Determining the risk for the object may further comprise determining the risk for the object by applying weights according to the type of the object.

The method may further comprise controlling steering system provided in the vehicle such that the vehicle moves to the determined driving position of the vehicle.

The method may further comprise generating a virtual lane for moving the vehicle to the determined driving position of the vehicle.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 illustrates a configuration of a vehicle according to an embodiment.

FIG. 2 illustrates a configuration of a driver assistance system according to an embodiment.

FIG. 3 illustrates a camera and a radar included in a driver assistance system according to an embodiment.

FIG. 4 and FIG. 5 illustrates an example among functions of a driver assistance system for describing in detail a lane keeping assistance system according to an exemplary embodiment.

FIG. 6 is a flowchart illustrating a driver assistance method according to an exemplary embodiment.

### DETAILED DESCRIPTION

Reference will now be made in detail to the embodiments of the present disclosure, examples of which are illustrated in the accompanying drawings, wherein like reference numerals refer to like elements throughout. This specification does not describe all elements of the embodiments of the present disclosure and detailed descriptions on what are well known in the art or redundant descriptions on substantially the same configurations may be omitted. The terms ‘unit, module, member, and block’ used herein may be implemented using a software or hardware component. According to an embodiment, a plurality of ‘units, modules, members, or blocks’ may also be implemented using an element and one ‘unit, module, member, or block’ may include a plurality of elements.

Throughout the specification, when an element is referred to as being “connected to” another element, it may be directly or indirectly connected to the other element and the “indirectly connected to” includes being connected to the other element via a wireless communication network.

Also, it is to be understood that the terms “include” and “have” are intended to indicate the existence of elements disclosed in the specification, and are not intended to preclude the possibility that one or more other elements may exist or may be added.

The terms first, second, etc. are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, embodiments of the present disclosure will be described in detail with reference to the accompanying drawings.

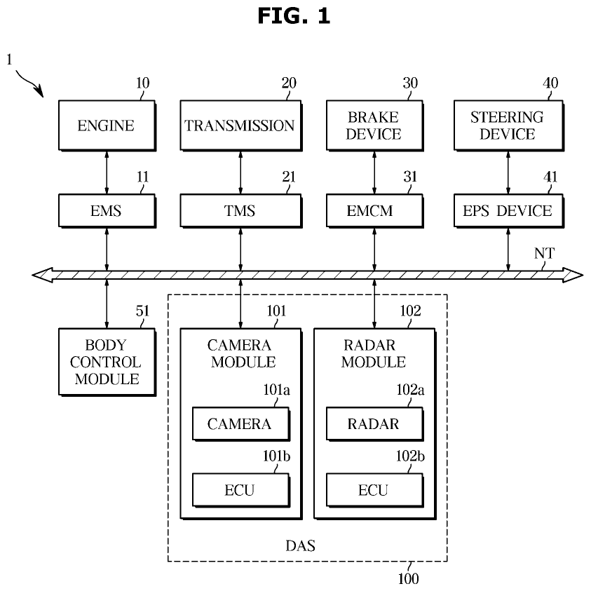

FIG. 1 illustrates a configuration of a vehicle according to an embodiment.

Referring to FIG. 1, the vehicle 1 may include an engine 10, a transmission 20, a brake device 30, and a steering device 40. The engine 10 may include at least one cylinder and at least one piston, and may generate power needed to drive the vehicle 1. The transmission 20 may include a plurality of gears, and may transmit power generated by the engine 10 to wheels of the vehicle 1. The brake device 30 may decelerate or stop the vehicle 1 through frictional force on wheels.

The vehicle 1 may include a plurality of electronic constituent elements. For example, the vehicle 1 may further include an Engine Management System (EMS) 11, a Transmission Controller also referred to as a Transmission Control Unit (TCU) 21, an Electronic Brake Controller also referred to as an Electronic Brake Control Module (EBCM) 31, an Electronic Power Steering (EPS) device 41, a Body Control Module (BCM), and a Driver Assistance System (DAS) 100.

The EMS 11 may control the engine 10 in response to either the driver's acceleration intention from the acceleration pedal or a request signal from the driver assistance system (DAS) 100. For example, the EMS 11 may control torque of the engine 10.

The TCU 21 may control the transmission 20 in response to either a driver's gearshift command activated by a gearshift lever and/or a driving speed of the vehicle 1. For example, the TCU 21 may adjust or regulate a gearshift ratio from the engine 10 to wheels of the vehicle 1.

The electronic brake control module (EBCM) 31 may control a brake device 30 in response to either the driver's brake intention from a brake pedal or slippage of wheels. For example, the EBCM 31 may temporarily release wheel braking in response to wheel slippage detected in a braking mode of the vehicle 1, resulting in implementation of an Anti-lock Braking System (ABS). The EBCM 31 may selectively release braking of wheels in response to oversteering and/or understeering detected in a steering mode of the vehicle 1, resulting in implantation of Electronic Stability Control (ESC). In addition, the EBCM 31 may temporarily brake wheels in response to wheel slippage detected by vehicle driving, resulting in implementation of a Traction Control System (TCS).

The electronic power steering (EPS) device 41 may assist the steering device 40 in response to the driver's steering intention from the steering wheel, such that the EPS device 41 may assist the driver in easily handling the steering wheel. For example, the EPS device 41 may assist the steering wheel 40 in a manner that steering force decreases in a low-speed driving mode or a parking mode of the vehicle 1 but increases in a high-speed driving mode of the vehicle 1.

A body control module 51 may control various electronic components that are capable of providing the driver with user convenience or guaranteeing driver safety. For example, the body control module 51 may control headlamps (headlights), wipers, an instrument or other cluster, a multifunctional switch, turn signal indicators, or the like.

The driver assistance system (DAS) 100 may assist the driver in easily handling (e.g., driving, braking, and steering) the vehicle 1. For example, the DAS 100 may detect peripheral environments (e.g., a peripheral vehicle, pedestrian, cyclist, lane, traffic sign, or the like) of the vehicle 1 (i.e., host vehicle), and may perform driving, braking, and/or steering of the vehicle 1 in response to the detected peripheral environments.

The DAS 100 may provide the driver with various functions. For example, the DAS 100 may provide the driver with a Lane Departure Warning (LDW) function, a Lane Keeping Assist (LKA) function, a High Beam Assist (HBA) function, an Autonomous Emergency Braking (AEB) function, a Traffic Sign Recognition (TSR) function, a Smart Cruise Control (SCC) function, a Blind Spot Detection (BSD) function, or the like.

The DAS 100 may include a camera module 101 operative to acquire image data of a peripheral region of the vehicle 1, and a radar module 102 operative to acquire data about a peripheral object present in the peripheral region of the vehicle 1.

The camera module 101 may include a camera 101a or multiple cameras and an Electronic Control Unit (ECU) controller 101b and may capture an image including a forward region of the vehicle 1 and process the captured image to recognize peripheral vehicles, pedestrians, cyclists, lanes, traffic signs, or the like in the captured image.

The radar module 102 may include a radar 102a or multiple radars and an Electronic Control Unit (ECU) controller 102b, and may acquire a relative position, a relative speed, or the like of the peripheral object (e.g., a peripheral vehicle, a pedestrian, or a cyclist) of the vehicle 1 based on sensed radar data.

The above-mentioned electronic components may communicate with each other through a vehicle communication network (NT). For example, the electronic components may perform data communication through Ethernet, Media Oriented Systems Transport (MOST), a FlexRay, a Controller Area Network (CAN), a Local Interconnect Network (LIN), or the like. For example, the DAS 100 may respectively transmit a drive control signal, a brake signal, and a steering signal to the EMS 11, the EBCM 31, and the EPS device 41 over the vehicle communication network (NT).

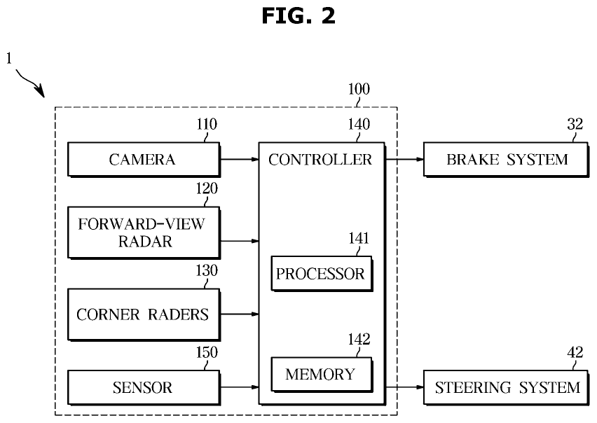

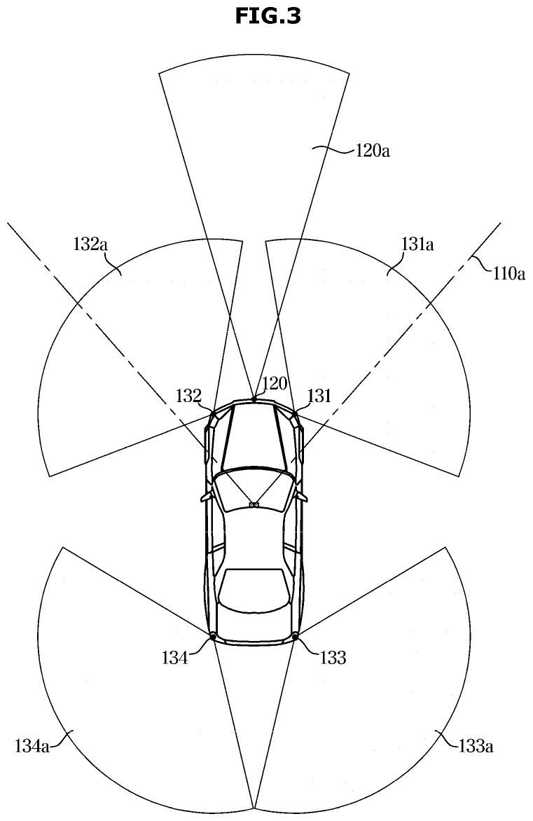

FIG. 2 is a block diagram illustrating the driver assistance system (DAS) according to an embodiment of the present disclosure. FIG. 3 is a conceptual diagram illustrating fields of view/sensing of a camera and a radar device for use in the driver assistance system (DAS) according to an embodiment of the present disclosure.

Referring to FIG. 2, the vehicle 1 may include a brake system 32, a steering system 42, and a driver assistance system (DAS) 100.

The brake system 32 may include the Electronic Brake Controller or Electronic Brake Control Module (EBCM) 31 (see FIG. 1) and the steering system 42 may include the Electronic Power Steering (EPS) device 41 (see FIG. 1) and the steering device 40 (see FIG. 1).

The DAS 100 may include one or more of a forward-view camera 110, a forward-view radar 120, and a plurality of corner radars 130.

The forward-view camera 110 may include a Field of View (FOV) 110a oriented to the forward region of the vehicle 1, as shown in FIG. 3. The forward-view camera 110 may be installed at a windshield of the vehicle 1.

The forward-view camera 110 may capture an image of the forward region of the vehicle 1, and may acquire data of the forward-view image of the vehicle 1. The forward-view image data of the vehicle 1 may include information about the position of a peripheral vehicle, a pedestrian, a cyclist, or a lane located in the forward region of the vehicle 1.

The forward-view camera 110 may include a plurality of lenses and a plurality of image sensors. Each image sensor may include a plurality of photodiodes to convert light into electrical signals, and the photodiodes may be arranged in a two-dimensional (2D) matrix.

The forward-view camera 110 may be electrically coupled to the processor or controller 140. For example, the forward-view camera 110 may be connected to the controller 140 through a vehicle communication network (NT), Hardwires, or a Printed Circuit Board (PCB).

The forward-view camera 110 may transmit the forward-view image data of the vehicle 1 to the controller 140.

The forward-view radar 120 may include a Field of Sensing (FOS) 120a oriented to the forward region of the vehicle 1 as shown in FIG. 3. The forward-view radar 120 may be mounted to, for example, a grille or a bumper of the vehicle 1.

The forward-view radar 120 may include a transmission (Tx) antenna (or a transmission (Tx) antenna array) to emit transmission (Tx) waves to the forward region of the vehicle 1 and a reception (Rx) antenna (or a reception (Rx) antenna array) to receive waves reflected from any object located in the FOS. The forward-view radar 120 may acquire forward-view radar data not only from Tx waves received from the Tx antenna, but also from reflected waves received from the Rx antenna. The forward-view radar data may include not only information about a distance between the host vehicle 1 and a peripheral vehicle (or a pedestrian or cyclist or other preceding object) located in the forward region of the host vehicle 1, but also information about a speed of the peripheral vehicle, the pedestrian, or the cyclist. The forward-view radar 120 may calculate a relative distance between the host vehicle 1 and any object based on a difference in phase (or difference in time) between Tx waves and reflected waves, and may calculate a relative speed of the object based on a difference in frequency between the Tx waves and the reflected waves.

For example, the forward-view radar 120 may be coupled to the controller 140 through a vehicle communication network (NT), Hardwires, or a PCB. The forward-view radar 120 may transmit forward-view radar data to the controller 140.

The plurality of corner radars 130 may include a first corner radar 131 mounted to a forward right side of the vehicle 1, a second corner radar 132 mounted to a forward left side of the vehicle 1, a third corner radar 133 mounted to a rear right side of the vehicle 1, and a fourth corner radar 134 mounted to a rear left side of the vehicle 1.

The first corner radar 131 may include a field of sensing (FOS) 131a oriented to a forward right region of the vehicle 1, as shown in FIG. 3. For example, the forward-view radar 120 may be mounted to a right side of a front bumper of the vehicle 1. The second corner radar 132 may include an FOS 132a oriented to a forward left region of the vehicle 1, and may be mounted to, for example, a left side of the front bumper of the vehicle 1. The third corner radar 133 may include an FOS 133a oriented to a rear right region of the vehicle 1, and may be mounted to, for example, a right side of a rear bumper of the vehicle 1. The fourth corner radar 134 may include an FOS 134a oriented to a rear left region of the vehicle 1, and may be mounted to, for example, a left side of the rear bumper of the vehicle 1.

Each of the first, second, third, and fourth radars 131, 132, 133, and 134 may include a transmission (Tx) antenna and a reception (Rx) antenna. The first, second, third, and fourth corner radars 131, 132, 133, and 134 may respectively acquire first corner radar data, second corner radar data, third corner radar data, and fourth corner radar data. The first corner radar data may include information about a distance between the host vehicle 1 and an object (e.g., a peripheral vehicle, a pedestrian, or a cyclist) present in a forward right region of the host vehicle 1, and information about a speed of the object. The second corner radar data may include information about a distance between the host vehicle 1 and an object (e.g., a peripheral vehicle, a pedestrian, or a cyclist) present in a forward left region of the host vehicle 1, and information about a speed of the object. The third corner radar data may include information about a distance between the host vehicle 1 and an object (e.g., a peripheral vehicle, a pedestrian, or a cyclist) present in a rear right region of the host vehicle 1, and information about a speed of the object. The fourth corner radar data may include information about a distance between the host vehicle 1 and an object (e.g., a peripheral vehicle, a pedestrian, or a cyclist) present in a rear left region of the host vehicle 1, and information about a speed of the object.

Each of the first, second, third, and fourth corner radars 131, 132, 133, and 134 may be connected to the controller 140 through, for example, a vehicle communication network NT, Hardwires, or a PCB. The first, second, third, and fourth corner radars 131, 132, 133, and 134 may respectively transmit first corner radar data, second corner radar data, third corner radar data, and fourth corner radar data to the controller 140.

Such radars may be implemented in Lidar.

The controller 140 may include a controller (ECU) 101b (see FIG. 1) of the camera module 101 (see FIG. 1), a controller (ECU) 102b (see FIG. 2) of the radar module 102 (see FIG. 1), and/or an additional integrated controller.

The controller 140 may include a processor 141 and a memory 142. The controller 140 may include one or more processors 141.

In detail, the processor 141 may obtain location information (distance and direction) and speed information (relative speed) of objects in front of the vehicle 1 based on the front radar data of the forward-view radar 120. The processor 141 may determine location information (direction) and type information (eg, whether the object is another vehicle, a pedestrian, or a cyclist) based on the front image data of the camera 110). In addition, the processor 141 matches the objects detected by the front image data to the detected objects by the front radar data, and based on the matching result, the type information, the position information, and the speed information of the front objects of the vehicle 1 can be obtained.

The processor 141 may generate a braking signal and a steering signal based on the type information, the location information, and the speed information of the front objects.

For example, the processor 141 may estimate a time to collision (TTC), which is a time until a collision between the vehicle 1 and the front object based on the position information (distance) and the speed information (relative speed) of the front objects). The processor 141 may also warn the driver of a collision or transmit a braking signal to the braking system 32 based on a comparison result between the estimated collision time and the predetermined reference time.

In response to the collision anticipated time that is less than the first predetermined reference time, the processor 141 may cause the audio and/or display to output a warning. In response to the collision anticipated time less than the second predetermined reference time, the processor 141 may transmit a pre-braking signal to the braking system 32. In response to the collision anticipated time less than the third predetermined reference time, the processor 141 may transmit an emergency braking signal to the braking system 32. At this time, the second reference time is smaller than the first reference time, and the third reference time is smaller than the second reference time.

As another example, the processor 141 calculates a distance to collision (DTC) based on the velocity information (relative velocity) of the forward objects, and compares the result between the distance to the collision and the distance to the forward objects and can alert the driver to a collision or transmit a braking signal to the braking system 32.

The processor 141 can obtain the position information (distance and direction) and the speed of the objects of the vehicle 1 side (front right, front left, rear right, rear left) Information (relative speed) based on the corner radar data of the plurality of corner radar 130.

The memory 142 may store programs and/or data needed for allowing the processor 141 to process image data, may store programs and/or data needed for the processor 141 to process radar data, and may store programs and/or data needed for the processor 141 to generate a brake signal and/or a steering signal.

The memory 142 may temporarily store image data received from the forward-view camera 110 and/or radar data received from the radars 120 and 130, and may also temporarily store the processed results of the image data and/or the radar data handled by the processor 141.

The memory 142 may include not only a volatile memory, such as a Static Random Access memory (SRAM) or a Dynamic Random Access Memory (DRAM), but also a non-volatile memory, such as a flash memory, a Read Only Memory (ROM), or an Erasable Programmable Read Only Memory (EPROM).

One or more processors included in the controller 140 may be integrated on one chip, or may be physically separated. In addition, the memory 140 and the controller 140 may be implemented as a single chip.

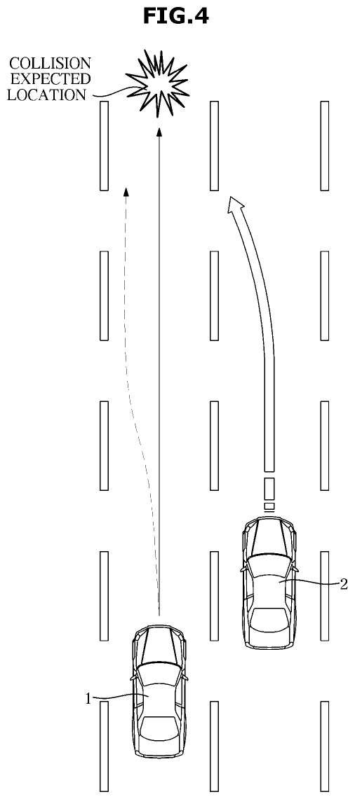

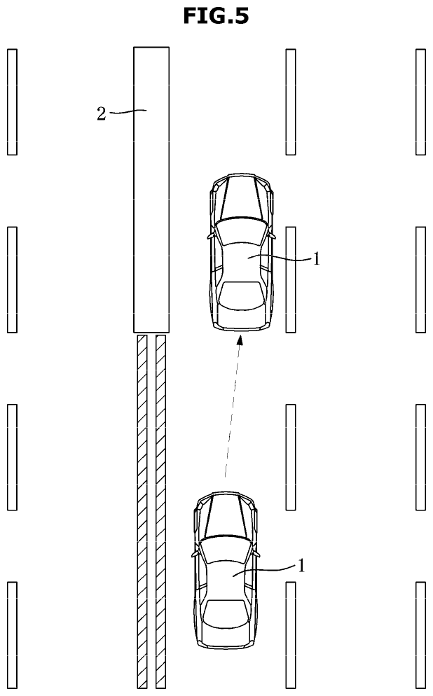

FIG. 4 and FIG. 5 illustrates an example among functions of a driver assistance system for describing in detail a lane keeping assistance system according to an exemplary embodiment.

The lane keeping assistance system detects a driving lane and controls the steering system 42 provided in the vehicle 1 so as not to leave the driving lane to generate the auxiliary steering torque.

On the other hand, the vehicle 1 may be provided with various sensors 150 for acquiring the behavior information of the vehicle. For example, the vehicle 1 includes a speed sensor for detecting a speed of a wheel, a lateral acceleration sensor for detecting a lateral acceleration of the vehicle, a yaw rate sensor for detecting a change in the angular velocity of the vehicle, a gyro sensor for detecting a tilt of the vehicle, and a steering angle sensor for detecting a rotation and steering angle of the steering wheel.

The controller 140 may process the image data acquired by the camera 110 to identify an object outside the vehicle 1. In addition, the controller 140 may identify the type of the object. Objects outside the vehicle 1 may include lanes, curbs, guardrails, structures on roads such as median dividers, surrounding vehicles, obstacles on driving lanes, pedestrians, and the like.

The controller 140 may obtain location information of the object. The location information of the object may include at least one of a current location of the object, a distance to the object, a moving speed of the object, and an expected moving path of the object.

When the controller 140 identifies the moving object, the controller 140 may detect a moving speed of the object and predict a moving path of the object based on the current position of the object and a position predicted after a predetermined time.

In addition, the controller 140 may process the image data to detect a curved section, a shoulder, a side slope of a road, and the like. The side slope of a road is a concept that includes terrain that is not continuous with the lane, such as cliffs.

The controller 140 may obtain behavior information of the vehicle 1 including the speed, the longitudinal acceleration, the lateral acceleration, the steering angle, the driving direction, the yaw rate, and the like of the vehicle 1 by processing the radar data obtained from radars 120, 130.

The controller 140 may determine a collision possibility with the identified object, determine a risk for the object, and determine a driving position of the vehicle 1 in the driving lane based on the risk for the object. In addition, the controller 140 may classify the risk of the object into a left-side risk of the vehicle and a right-side risk of the vehicle based on the location information of the object.

The controller 140 may determine a collision possibility based on an estimated time to collision between the vehicle 1 and the object. The controller 140 may determine the determined collision possibility as the risk for the object. In addition, the controller 140 may further determine the risk of the object by further considering the weight of the object. The weight for the object may be set differently according to the type of the object.

The controller 140 may determine the driving position of the vehicle 1 in the driving lane based on the degree of danger for the object. The controller 140 controls the vehicle 1 so that the vehicle 1 is deflected to the left lane or to the right lane within the driving lane based on the left-side risk of the vehicle 1 and the right-side risk of the vehicle 1.

In other words, the controller 140 may determine the distance from which the vehicle 1 is spaced apart from the left lane and/or the right lane based on the left-side risk of the vehicle 1 and the right-side risk of the vehicle 1. In this case, the controller 140 may generate a virtual lane for moving the vehicle 1 to the determined driving position.

In addition, the controller 140 may control the steering system 42 provided in the vehicle 1 so that the vehicle 1 moves to the determined driving position. The controller 140 controls the steering system 42 to move the vehicle 1 along the virtual lane.

Referring to FIG. 4, the camera 110 of the driver assistance system 100 may acquire image data about an object (another vehicle) 2 existing on the right side of the vehicle 1 and a current driving lane of the vehicle 1.

The controller 140 may process the image data to identify the object 2 and obtain location information of the object 2. That is, in FIG. 5, the controller 140 identifies position information of the other vehicle 2 and detects the other vehicle 2 is located on the right side of the vehicle and the moving speed and the expected moving path of the other vehicle 2

In addition, the controller 140 may process the data acquired by the sensor 150 provided in the vehicle 1 to obtain behavior information of the vehicle 1. For example, the controller 140 may acquire the current speed, the longitudinal acceleration, the lateral acceleration, the steering angle, the driving direction, and the like of the vehicle 1, and may predict the movement path of the vehicle 1.

The controller 140 may determine an estimated time to collision between the vehicle 1 and the other vehicle 1 based on the location information of the other vehicle 2 and the behavior information of the vehicle 1, and the risk for the other vehicle 2 can be determined based on the estimated time to collision. The estimated time to collision can be estimated using the moving path and the moving speed of the vehicle 1 and the other vehicle 2.

The controller 140 may determine a collision possibility with another vehicle 2 based on the estimated time to collision. For example, it may be determined that collision probability is 30% when the time to collision is 5 seconds and collision probability is 90% when the time to collision is 2 seconds. The controller 140 may determine the determined collision possibility as a risk for the other vehicle 2. That is, when the estimated time to collision is 5 seconds, the risk may be determined to be 30%, and when the estimated time to collision is 2 seconds, the risk may be determined to be 90%. Such numerical values are exemplary and not limited thereto.

In addition, the controller 140 may further apply a weight for the other vehicle 2 to determine a risk level for the other vehicle 2. As described above, various kinds of objects, such as pedestrians, structures on the road, and other vehicles, may be identified, and the degree of danger or the degree of risk may be different in a collision for each type of object. For example, the risk of collision with other vehicles is higher than the risk of collision with structures on the road. Therefore, the weight for the other vehicle may be set higher than the weight for the structure on the road.

As such, it is necessary to set weights according to the types of objects, and determine the risks of the identified objects by applying the weights. This weight may be set variously.

In addition, the relationship between the time to collision time and the collision possibility, and the relationship between the time to collision and the risk may be stored in the memory 142 as predetermined data. When the time to collision is determined, the controller 140 may extract a risk matching the time to collision from the memory 142.

In addition, since the other vehicle 2 is located on the right side of the vehicle 1, the controller 140 may determine that the right-side risk of the vehicle 1 is higher than the left-side risk of the vehicle 1.

Therefore, the controller 140 may determine the driving position of the vehicle 1 such that the vehicle 1 is deflected to the left lane in the driving lane so as to avoid a collision with another vehicle 2. The controller 140 may determine the driving position of the vehicle 1 such that the vehicle 1 is deflected to the left lane as the risk for the other vehicle 2 is higher. The controller 140 may generate a virtual lane or a virtual path for the vehicle 1 to move to the determined driving position. In FIG. 4, the virtual lane or the virtual path is shown by a dotted line.

The controller 140 may control the steering system 42 to move the vehicle 1 to the determined driving position along the virtual lane. That is, the controller 140 may control the steering system 42 such that the vehicle 1 is driven in a left lane. Therefore, the vehicle 1 can be prevented from colliding with another vehicle 2.

FIG. 5 shows the case where the central separator or guard rail 2 is identified on the left side of the vehicle 1 while the vehicle 1 is running.

In FIG. 5, the collision possibility between the vehicle 1 and the guard rail 2 may be seen to be low. However, if there is a curved section ahead, there is a possibility that collision between the vehicle 1 and the guard rail 2 occurs. When the curved section exists in front of the vehicle, the controller 140 may determine the estimated time to collision using the speed of the vehicle 1 and the distance to the curved section.

In addition, since the damage to the vehicle 1 and the driver will be great when the collision with the guard rail 2, the risk for the guard rail 2 can be said to be greater than the risk for the right lane. Accordingly, the weight for the guardrail 2 may be set higher than the weight for the right lane.

The controller 140 determines that the risk for the guard rail 2 on the left side of the vehicle 1 is greater than the risk for the right lane of the vehicle 1 by applying a weight to the guard rail 2, and the vehicle 1 may determine the driving position of the vehicle 1 so as to be deflected in the right lane. In addition, the controller 140 may generate a virtual lane or a virtual path for the vehicle 1 to move to the determined driving position. In FIG. 5, the virtual lane or the virtual path is shown by a dotted line. The controller 140 controls the steering system 42 of the vehicle 1 to move the vehicle 1 to the determined travel position.

The controller 140 may generate a virtual lane having a predetermined width. For example, the virtual lane may have a width corresponding to the width of the vehicle 1. The width of the virtual lane may be preset. In addition, when the identified object is a fixed structure on a road such as a curb or a guardrail, the controller 140 generates a virtual lane having a width narrower than that of the actual lane so that the object and the vehicle 1 are spaced apart from each other. The steering system 42 may be controlled to move the vehicle 1 along the virtual lane.

As such, the driver assistance system 100 of the present disclosure may determine the driving position of the vehicle 1 in the driving lane by identifying the road state and the structure on the road ahead. Therefore, it is possible to increase the safety of the driving and to provide a psychological stability to the user.

Meanwhile, as an example, a plurality of objects may exist in front of the vehicle 1. The controller 140 may identify the plurality of objects based on at least one of the image data and the radar data. In addition, the controller 140 determines a time to collision for each of the plurality of objects based on the location information of each of the plurality of objects and the behavior information of the vehicle 1, and applies a weight to each of the plurality of objects to determine the risk for each of the objects.

In addition, some of the plurality of objects may be located on the left side of the vehicle 1, and others may be located on the right side of the vehicle 1. The controller 140 may determine the left-side risk of the vehicle 1 and the right-side risk of the vehicle 1 based on the location information of each of the plurality of objects.

For example, if the number of objects located on the left side of the vehicle 1 is greater than the number of objects located on the right side of the vehicle 1, the controller 140 may determine that the left-side risk of the vehicle 1 is higher than the right-side risk of the vehicle 1. Therefore, the controller 140 may determine the driving position of the vehicle 1 so that the vehicle 1 deflects to the right lane, and control the steering system 42 to move the vehicle 1 to the determined driving position.

As described above, the driver assistance system 100 of the present disclosure can identify a plurality of objects and determine the deflection driving of the vehicle 1 based on a risk level for each of the plurality of objects, thereby increasing safety of driving. Also, accidents can be prevented and damage can be reduced even if an accident occurs.

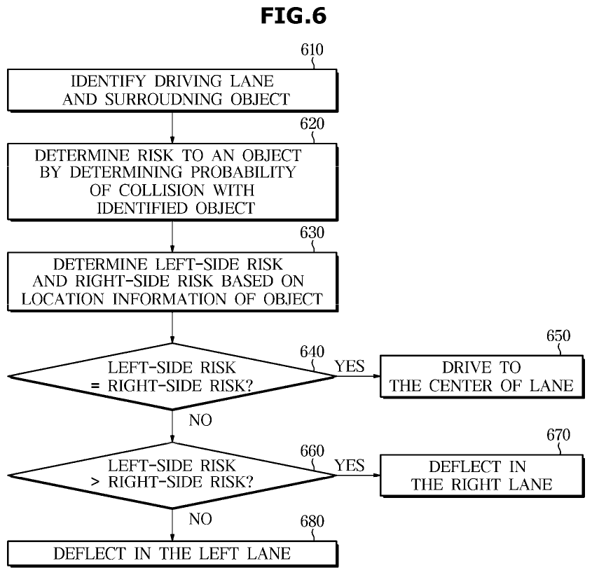

FIG. 6 is a flowchart illustrating a driver assistance method according to an exemplary embodiment.

Referring to FIG. 6, the controller 140 of the driver assistance system 100 may identify an object outside the vehicle 1 by processing at least one of the image data acquired by the camera 110 and the radar data obtained by the radar 120 and 130 (610). As described above, an object outside the vehicle 1 may include a driving lane, a lane, a structure on a road, a surrounding vehicle, a pedestrian, and the like.

The controller 140 determines a collision possibility with the identified object to determine a risk for the object (620). In addition, the controller 140 may determine the risk for the object based on the location information of the object by dividing it into a left-side risk of the vehicle 1 and a right-side risk of the vehicle 1 (630).

The controller 140 may determine the driving position of the vehicle 1 in the driving lane based on the risk for the object. The controller 140 controls the vehicle 1 so that the vehicle 1 is deflected to the left lane or to the right lane within the driving lane based on the left-side risk of the vehicle 1 and the right-side risk of the vehicle 1.

When the left-side risk and the right-side risk of the vehicle 1 are the same, the controller 140 determines the driving position of the vehicle 1 as the center of the lane (640, 650). If the left-side risk of the vehicle 1 is greater than the right-side risk, the controller 140 determines that the driving position of the vehicle 1 is deflected to the right lane, and the steering system 42 is controlled to move the vehicle 1 (660, 670). On the contrary, when the right-side risk of the vehicle 1 is greater than the left-side risk, the controller 140 determines that the driving position of the vehicle 1 is deflected to the left lane, and the steering system 42 is controlled to move the vehicle 1 (660, 680).

As such, the driver assistance system and the control method of the present invention may determine the deflection driving in the driving lane based on the collision risk of the detected object. As a result, driving safety can be increased, and reliability for autonomous driving can be increased. In addition, it is possible to quickly cope with the collision situation and minimize the damage.

The above-mentioned embodiments may be implemented in the form of recording medium storing commands capable of being executed by a computer system. The commands may be stored in the form of program code. When the commands are executed by the processor, a program module is generated by the commands so that the operations of the disclosed embodiments may be carried out. The recording medium may be implemented as a computer-readable recording medium.

The computer-readable recording medium includes all kinds of recording media storing data readable by a computer system. Examples of the computer-readable recording medium include a Read Only Memory (ROM), a Random Access Memory (RAM), a magnetic tape, a magnetic disk, a flash memory, an optical data storage device, or the like.

Although a few embodiments of the present disclosure have been shown and described, it would be appreciated by those skilled in the art that changes may be made in these embodiments without departing from the principles and spirit of the disclosure, the scope of which is defined in the claims and their equivalents.

According to the driver assistance system and the control method thereof, the driving of the deflection may be determined in the driving lane based on the collision risk of the detected object.

As a result, driving safety can be increased, and reliability for autonomous driving can be increased. In addition, it is possible to quickly cope with the collision situation and minimize the damage.

What is claimed is:

1. A driver assistance system (DAS) comprising:
a camera configured to be installed on the vehicle to have a field of view and obtain image data;
a radar configured to be installed on the vehicle to have a field of view outside and obtain radar data; and
a controller configured to include a processor to process the image data obtained by the camera and the radar data obtained by the radar data, wherein
the controller identifies an object based on at least one of the image data and the radar data, determines a risk for the object by determining collision possibility with the identified object, and determines driving position of the vehicle within a driving lane based on the risk for the object.

2. The driver assistance system according to claim 1, wherein
the controller determines the risk for the object by dividing with respect to left-side risk and right-side risk of the vehicle based on the location information of the object.

3. The driver assistance system according to claim 2, wherein
the controller determines the driving position of the vehicle to be deflected in the right lane or in the left lane within the driving lane based on the left-side risk and right-side risk of the vehicle.

4. The driver assistance system according to claim 1, wherein
the controller determines the risk for the object by determining time to collision with the object based on the location information of the object and behavior information of the vehicle.

5. The driver assistance system according to claim 4, wherein
the controller determines the risk for the object by applying weights according to the type of the object.

6. The driver assistance system according to claim 1, wherein
the controller controls steering system provided in the vehicle such that the vehicle moves to the determined driving position of the vehicle.

7. The driver assistance system according to claim 1, wherein
the controller generates a virtual lane for moving the vehicle to the determined driving position of the vehicle.

8. The control method of the driver assistance system includes a camera configured to be installed on the vehicle to have a field of view and obtain image data, a radar configured to be installed on the vehicle to have a field of view outside and obtain radar data, and a controller configured to include a processor to process the image data obtained by the camera and the radar data obtained by the radar data, the method comprising:
obtaining the image data by the camera;
obtaining the radar data by the radar
identifying an object based on at least one of the image data and the radar data;
determining a risk for the object by determining collision possibility with the identified object; and
determining driving position of the vehicle within a driving lane based on the risk for the object.

9. The method according to claim 8, wherein
determining the risk for the object further comprises determining the risk for the object by dividing with respect to left-side risk and right-side risk of the vehicle based on the location information of the object.

10. The method according to claim 9, wherein
determining driving position of the vehicle further comprises determines the driving position of the vehicle to be deflected in the right lane or in the left lane within the driving lane based on the left-side risk and right-side risk of the vehicle.

11. The method according to claim 8, wherein
determining the risk for the object comprises determining the risk for the object by determining time to collision with the object based on the location information of the object and behavior information of the vehicle.

12. The method according to claim 8, wherein
determining the risk for the object further comprises determining the risk for the object by applying weights according to the type of the object.

13. The method according to claim 8 further comprising:
controlling steering system provided in the vehicle such that the vehicle moves to the determined driving position of the vehicle.

14. The method according to claim 8 further comprising:
generating a virtual lane for moving the vehicle to the determined driving position of the vehicle.

15. A driver assistance system (DAS) comprising:
a camera configured to be installed on the vehicle to have a field of view and obtain image data;
a radar configured to be installed on the vehicle to have a field of view outside and obtain radar data;
at least one processor configured to be electrically connected to the camera and the radar;
at least one memory configured to be electrically connected to the processor; wherein
the memory stores at least one instructions being set to process the image data and the radar data, identify an object based on at least one of the image data and the radar data, determine a risk for the object by determining collision possibility with the identified object, and determines driving position of the vehicle within a driving lane based on the risk for the object by the at least one processor.

16. The driver assistance system according to claim 15, wherein
the memory stores at least one instructions being set to determine the risk for the object by dividing with respect to left-side risk and right-side risk of the vehicle based on the location information of the object.

17. The driver assistance system according to claim 16, wherein
the memory stores at least one instructions being set to determine the driving position of the vehicle to be deflected in the right lane or in the left lane within the driving lane based on the left-side risk and right-side risk of the vehicle.

18. The driver assistance system according to claim 15, wherein
the memory stores at least one instructions being set to determine the risk for the object by determining time to collision with the object based on the location information of the object and behavior information of the vehicle.
